(19) United States
(12) Patent Application Publication
(10) Pub. No.: US 2014/0153790 A1
(43) Pub. Date: Jun. 5, 2014

(54) Biometrics Touchscreen

(71) Applicant: Cherif Atia Algreatly, Newark, CA (US)

(72) Inventor: Cherif Atia Algreatly, Newark, CA (US)

(73) Assignee: Cherif Atia Algreatly, Newark, CA (US)

(21) Appl. No.: 14/147,528

(22) Filed: Jan. 4, 2014

Related U.S. Application Data
(63) Continuation-in-part of application No. 12/587,339, filed on Oct. 6, 2009.

(51) Int. Cl. G06K 9/00

(52) U.S. Cl. CPC G06K 9/00013
USPC 382/124

(57) ABSTRACT

The present invention discloses a thin transparent panel that can be built-in or attached to a touchscreen to detect the user's identity once the user touches the screen. It can be utilized with a mobile phone, tablet device, and computer touchscreen. The panel can also be attached to a computer keyboard, mouse, or touchpad to enable quick recognition of the user's identity once the user uses the keyboard, mouse, or touchpad. Generally, the present invention detects the measurements of the hand skeleton and compares these measurements with a database to recognize or confirm the user's identity.

### CROSS-REFERENCE TO RELATED APPLICATION

This application is a continuation-in-part of a U.S. patent application Ser. No. 12/587,339, filed Oct. 6, 2009, titled “Touch Sensing Technology”.

### BACKGROUND

The utilization of touchscreens in the construction of modern computers, tablets devices, and mobile phones is rapidly increasing. At the same time, the use of computers, tablet devices, and mobile phones for storing sensitive information or accessing personal online accounts is also growing. Methods for confirming and securing personal devices and private online information of the users are highly needed. Using additional hardware with the touchscreen such as iris-scanners or biometric fingertip readers is not a practical solution. The need for a solution that enables touchscreens to recognize the identity of its user without utilizing a special biometric hardware is apparent. This solution will make our information more protected in a society that counts mainly on touchscreens in accessing information.

### SUMMARY

The present invention discloses an innovative touchscreen that has the ability to recognize the identity of its user with one touch of two fingers. In one embodiment of the present invention, the touchscreen utilizes force sensors to detect the 3D direction of the two fingers and the force exerted of each finger when they are simultaneously touching the touchscreen. Detection of the 3D direction and the force exerted by each finger, in addition to the distance between the two fingers during the moment of touch determines certain measurements that accurately describe the hand skeleton. Comparison of these measurements with those stored in a database reveals the user's identity.

The two fingers used for biometrics touchscreen can be any two fingers from the same hand, such as the thumb and the index finger, the thumb and the middle finger, or the index finger and the middle finger. More than two fingers of the same hand can also be utilized in detecting the user's identity, such as the thumb, the index finger and the ring finger. The hand can be the left hand or the right hand. The touchscreen can be a touchscreen of a mobile phone, tablet, computer, or the like. The recognition of the user's identity can be done at the initial moment of use of the touchscreen to gain access to the device or the computer. The recognition of the user's identity can be continuous, prolonged period of time and not limited to initial use, which ensures that the one who began the use of the device is still the same person who is interacting with the device. Also for public computers, the recognition and storing of the users identities will be done each time a user identity is changed during use of the same computer.

### BRIEF DESCRIPTION OF THE DRAWINGS

FIGS. 1 to 4 illustrate two fingers of a hand simultaneously touching a touch panel and exerting two forces, each of which can be described with a 3D direction and a value.

FIG. 5 illustrates two fingers touching a touchscreen of a mobile phone, where the 3D direction and value of the force exerted by each finger on the touchscreen are detected.

FIGS. 6 and 7 illustrate the same two fingers touching a touchscreen of a mobile phone in two different configurations or patterns.

FIGS. 8 and 9 illustrate the skeleton of a hand, showing the distal, intermediate, proximal phalanges, metacarpals and carpals.

FIG. 10 illustrates utilizing the present invention with a computer keyboard to detect the user's identity whilst using the keyboard.

FIG. 11 illustrates utilizing the present invention with a computer mouse to detect the user's identity whilst using the mouse.

FIG. 12 illustrates a bottom view of five fingers simultaneously touching a touch screen that recognizes the user's identity.

FIGS. 13 to 15 illustrate the change of the 3D direction of a force exerted by a finger on a touchscreen with a change of the finger directions.

FIG. 16 illustrates a representation of a 3D direction of a force by a first angle located between the touchscreen plane and a line representing the 3D direction of the force, and a second angle located between the x-axis and the projection of the line on the touchscreen plane.

FIGS. 17 and 18 illustrate two fingers simultaneously touching a touchscreen to exert two forces parallel to the touchscreen plane

FIG. 19 illustrates a touch panel equipped with a plurality of force sensors to detect the points of touch, the 3D direction, and the values of the forces exerted from two or more fingers on the touch panel.

FIG. 20 illustrates three lines connected between three points on a touchscreen touched by three fingers.

### DETAILED DESCRIPTION

In one embodiment, the present invention discloses a touchscreen that recognizes the identity of a user touching the touchscreen by two fingers of a hand, wherein the touchscreen is comprised of;
a touch panel that detects the distance between the positions of touch of the two fingers;
a sensing unit that detects the 3D directions and the ratio between the forces exerted by the two fingers on the touch panel;
a database that associates each unique combination of a distance, and 3D directions and ratio between forces with a unique identity; and
a microprocessor that receives the data of the distance from the touch panel, and the data of the 3D directions and the ratio from the sensing unit to search and retrieve the user's identity form the database.

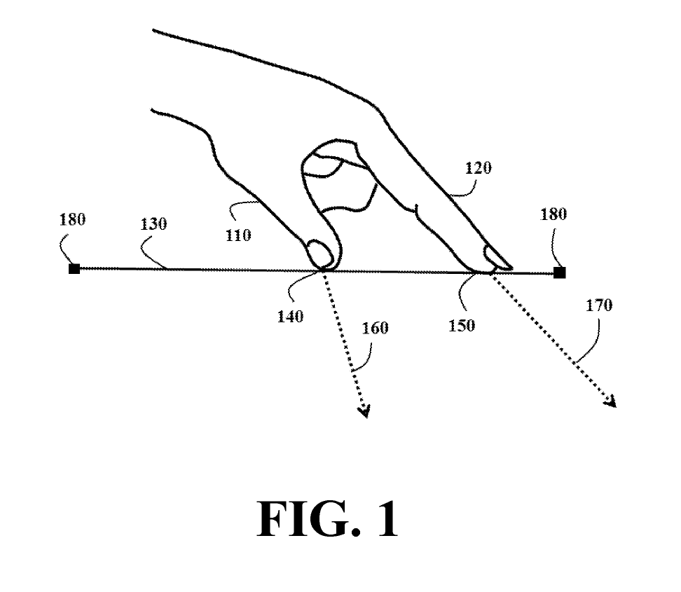

To clarify the function and operation of the present invention, FIG. 1 illustrates a thumb 110 and an index finger 120 of the same hand simultaneously touching a touch panel 130 at a first position 140, and a second position 150. The thumb exerts a first force 160 on the first position and the index finger exerts a second force 170 on the second position. The first force has a 3D direction and a value, and the second force also has a 3D direction and a value. The 3D directions and values of the first force and the second force are detected by a plurality of sensors 180 connected to a microprocessor.

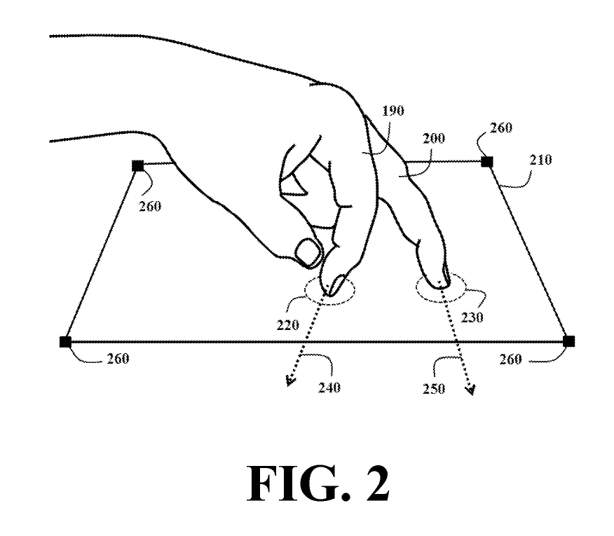

The thumb and index finger can be any combination of two fingers from the same hand. For example, FIG. 2 illustrates an index finger 190 and a middle finger 200 of the same hand simultaneously touching a touch panel 210 at a first position 220 and a second position 230. The value and the 3D direction of the first force 240 exerted by the index finger on the first position, and the value and the 3D direction of the second force 250 exerted by the middle finger on the second position are detected by a plurality of sensors 260 located at the boundary of the touch panel.

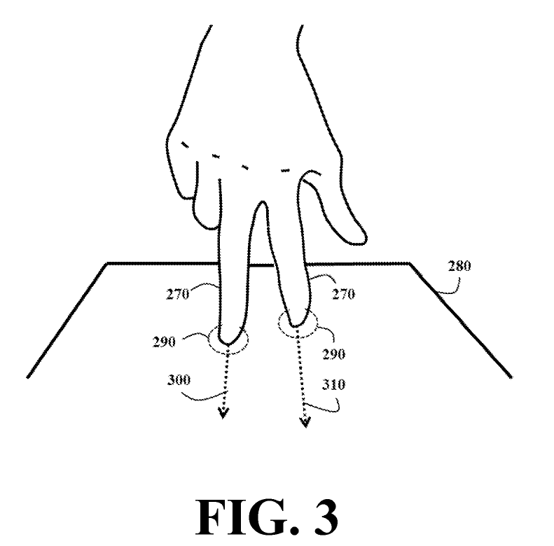

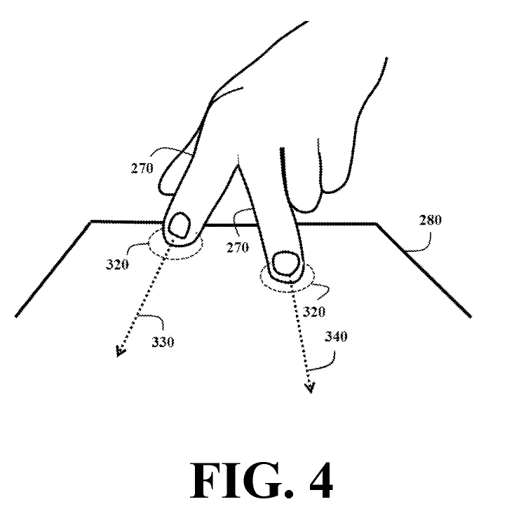

The configuration of the two fingers touching the touch panel can take various shapes. For example, FIG. 3 illustrates the index and middle fingers 270 touching a touch panel 280 at two positions 290 and exerting two forces 300 and 310 on the two positions. FIG. 4 illustrates the same index and middle fingers 270 touching the touch panel 280 at two new positions 320 to exert two forces 330 and 340 on the two new positions.

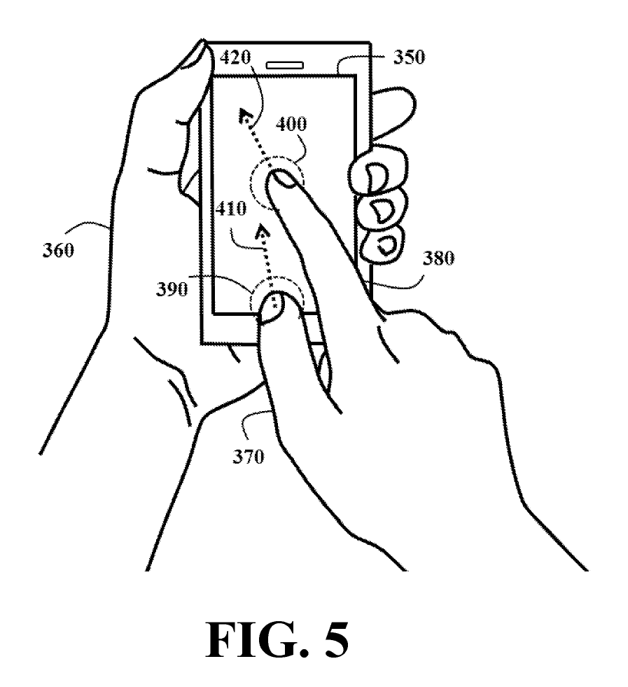

Generally, the touch panel can be the touchscreen of any mobile phone, tablet, or computer equipped with sensors to detect the 3D directions and values of the forces exerted from the two fingers on the touchscreen. For example, FIG. 5 illustrates a touchscreen of a mobile phone 350 held by a left hand 360, meant to be touched by the thumb 370 and the middle finger 380 of the right hand at a first position 390 and a second position 400. The 3D directions and values of the two forces are represented by the two dotted arrows 410 and 420 in the figure.

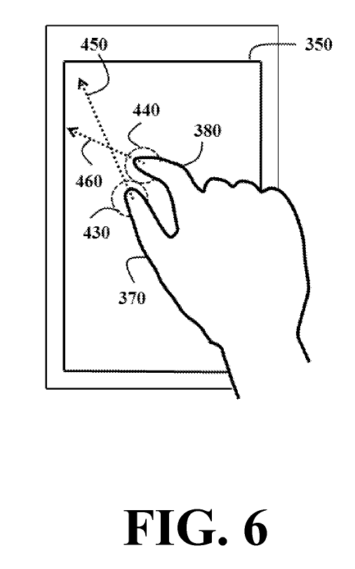

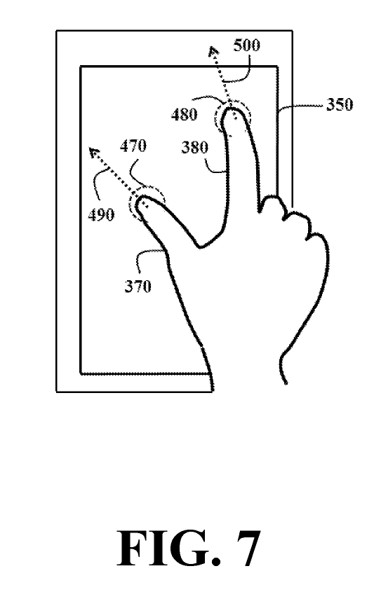

FIG. 6 illustrates another configuration of the same thumb and the index finger touching the same touchscreen of the mobile phone at two different positions 430 and 440 to exert another two different forces 450 and 460. Each one of the two different forces has a different 3D direction and value than the corresponding force of the previous example. FIG. 7 illustrates another configuration or pattern of the same thumb and index finger touching the same touchscreen of the mobile phone at two different positions 470 and 480 and exerting two different forces 490 and 500. Each one of the two different forces of this example has a different 3D direction and value than the corresponding forces of the two previous examples.

Generally, detecting the first position and the second position of the two points of touch by the two fingers determines the distance between the two positions of touch. Detecting the 3D directions and values of the two forces exerted by the two fingers determines the distribution of the hand force through the two fingers. The combination of the distance of the two positions of touch and the distribution of the hand force through the two fingers represents the uniqueness of the hand skeleton. The uniqueness of the hand skeleton can be described as the unique dimensions of the hand bones and the structure of the hand joints. The structure of the hand joints impacts the force translation from the hand through the two fingers to the touch panel.

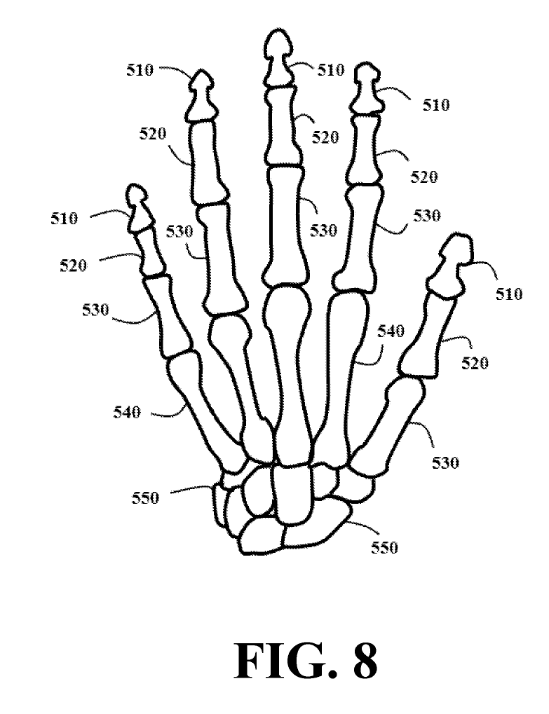

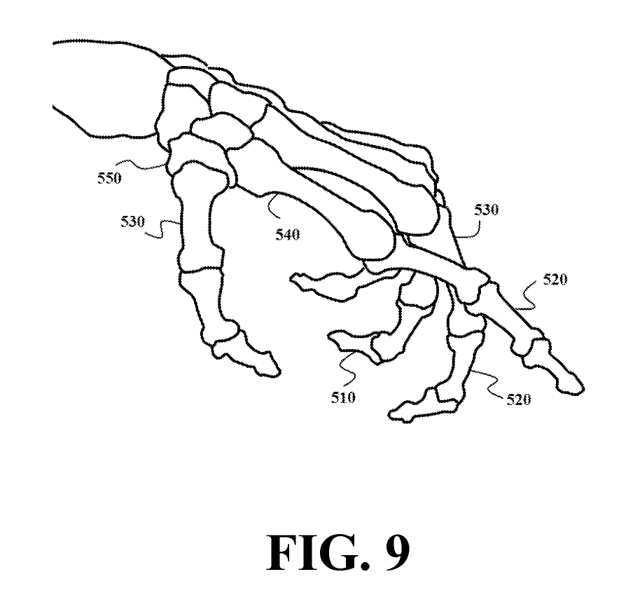

FIG. 8 illustrates the skeleton of the hand. As shown in the figure, the skeleton of each of the little, ring, middle, and index fingers is comprised of the distal phalange 510, intermediate phalange 520, and proximal phalange 530 connected to the metacarpals 540 and carpals 550. The skeleton of the thumb is comprised of the distal phalange 210 and proximal phalange 430 connected to the metacarpals 540 and carpals 550. FIG. 9 illustrates the shape of the hand skeleton when moving the hand fingers. In this case, the joints between the phalanges and metacarpals, and the joints between the metacarpals and carpals, fully effect the movement of the hand fingers.

It is important to note that each phalange, metacarpal, and carpal of a user's hand has different dimensions, shape, and connectivity with each other. This results in a different distance between the two points of touch touched by of the two fingers associated with different 3D directions of two forces exerted by the two fingers, and a different ratio between these two forces. Using these three parameters (the distance between the two points of touch; the 3D directions of the two forces; and the ratio between the two values of the two forces) enables recognition of the user's identity. Generally, recognition of the user's identity is achieved by using a database that associates each unique combination of the three aforementioned parameters with a unique ID.

To create the database, various methods are utilized. In one embodiment, the database is created by touching the touchscreen at all possible distances between two fingers and storing each distance with the corresponding 3D directions and values of the forces of the two fingers of the user. In another embodiment, the database is created by automatically storing the distances between the two fingers, the 3D directions and values of the forces of the two fingers each time the users touches the touchscreen.

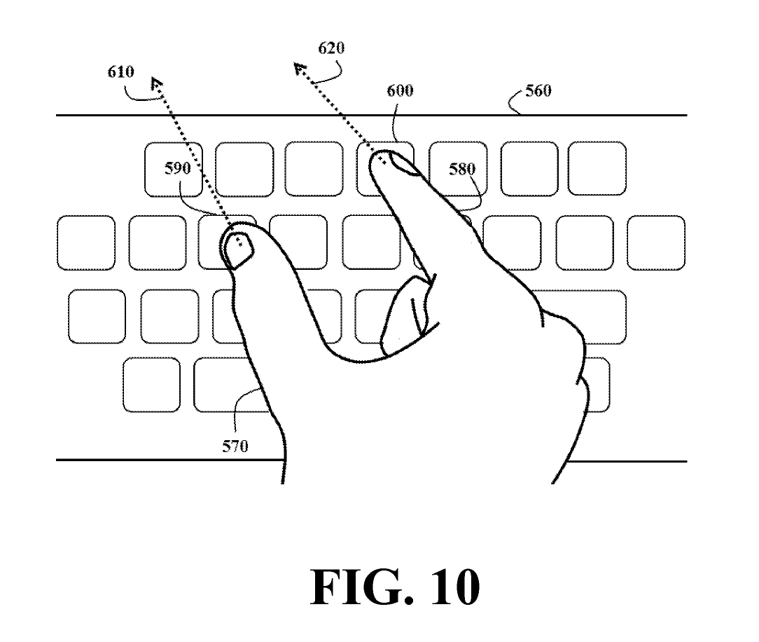

Generally, the present invention is utilized with other computer input devices rather than the touchscreen. For example, FIG. 10 illustrates a computer keyboard 560 that has the ability to detect the user's identity when the user's simultaneously touches two buttons of the keyboard. As shown in the figure, a first finger 570 and a second finger 580 are simultaneously touching a first button 590 and a second button 600 of the keyboard. The 3D direction and value of the first force 610 exerted by the first finger is detected by the first button. Also, the 3D direction and value of the second force 620 exerted by the second finger is detected by the second button as will be described subsequently.

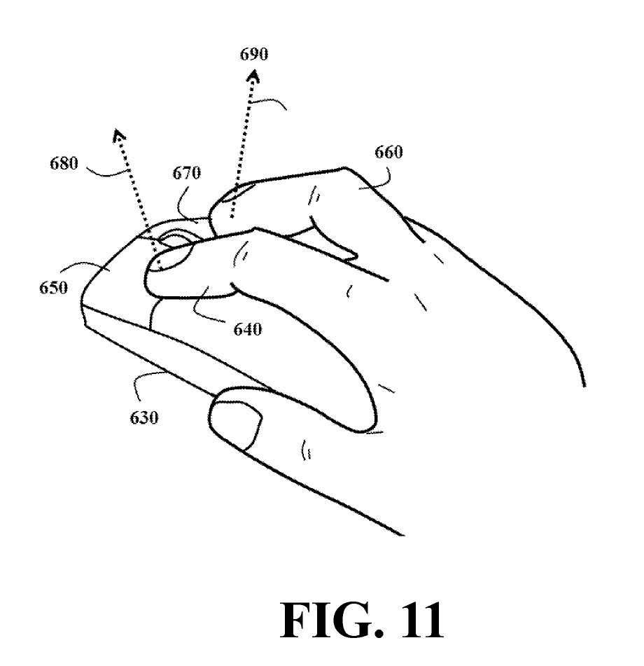

FIG. 11 illustrates utilizing the present invention with a computer mouse to detect the user's identity once the user touches the computer mouse. As shown in the figure, a computer mouse 630 is touched by a first finger 640 at the left button of the mouse 650, and a second finger 660 at the right button 670 of the mouse. The 3D direction and value of the first force 680 exerted by the first finger is detected by the left button of the mouse. Also the 3D direction and value of the second force 690 exerted by the second finger is detected by the right button of the mouse. It is important to note that in this example, the directions of the two forces are almost perpendicular to the two fingers.

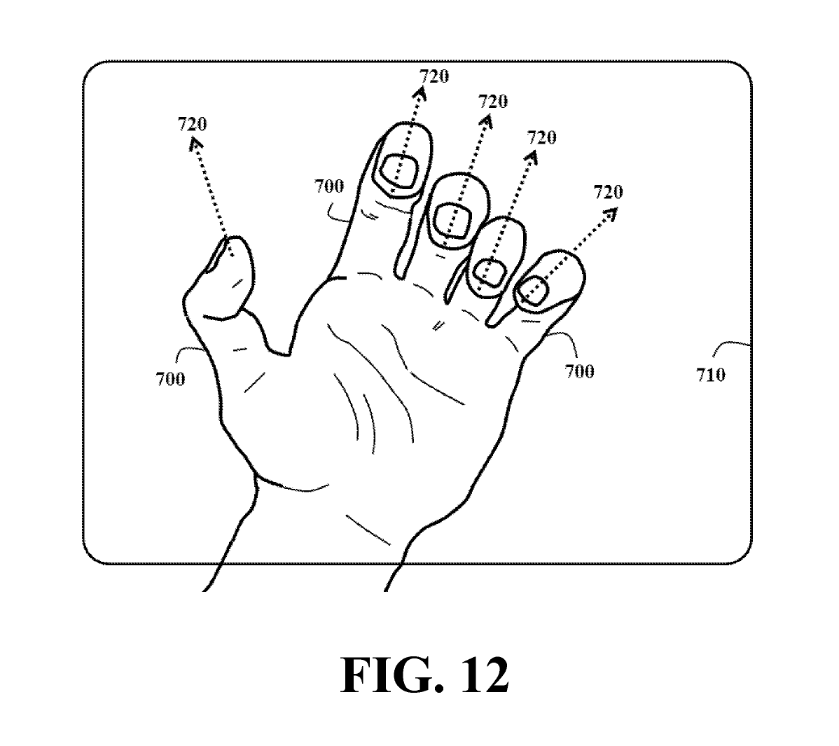

In one embodiment, the present invention detects the user's identity using more than two fingers. For example, the user's identity can be recognized when the user touches the touchscreen with any combination of three, four, or five fingers belonging to the same hand. FIG. 12 illustrates a bottom view of five fingers 700 of a hand simultaneously touching a touch screen 710, where the 3D directions and values of the five forces 720 exerted by the five fingers are detected by the touchscreen.

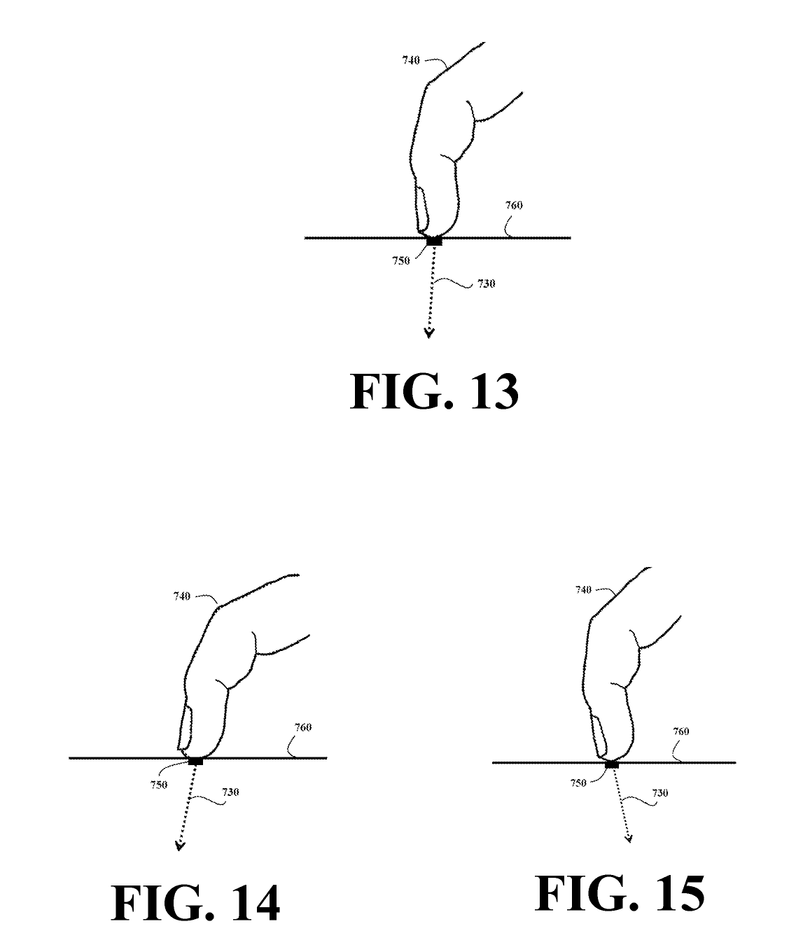

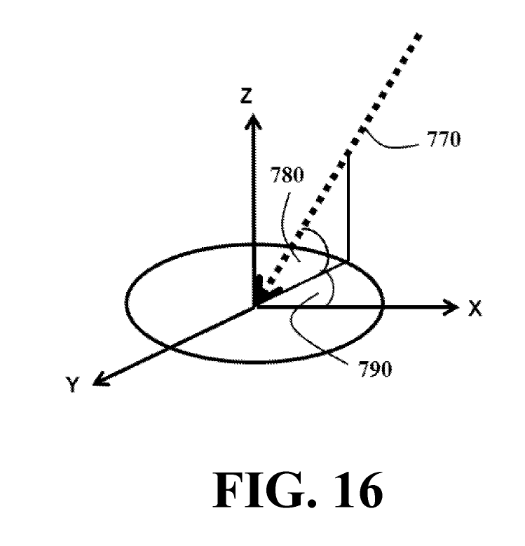

FIG. 13 illustrates the 3D direction of a force 730 exerted from a finger 740 on a point of touch 750 on a touchscreen. FIGS.14 and 15 illustrate the change of the 3D direction according to the little change of the finger configuration or rotation. FIG. 16 illustrates a representation of the 3D direction 760 of the force by a first angle 770 located between the touchscreen plane and a line representing the 3D direction of the force, and a second angle 780 located between the projection of the line on the touchscreen plane and the x-axis of touchscreen plane.

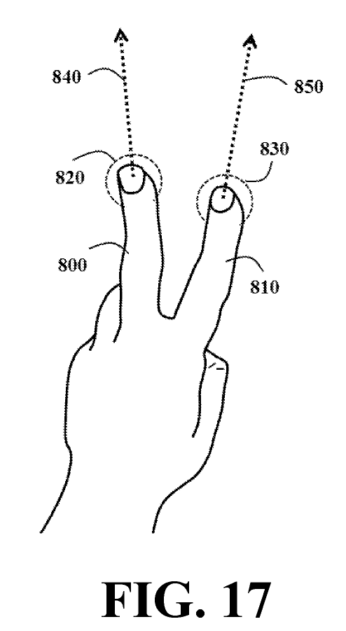

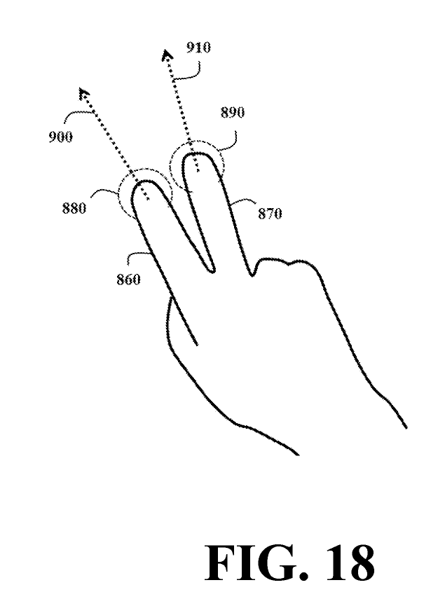

In another embodiment, the present invention recognizes the identity of the user when the forces exerted from the fingers on the touchscreen are horizontal forces. For example, FIG. 17 illustrates a first finger 800 and a second finger 810 simultaneously touching a first position 820 and a second position 830 of a touchscreen. The two forces 840 and 850 exerted from the two fingers are parallel to the touchscreen plane. In other words, the two forces exerted from the two fingers are horizontal relative to the touchscreen plane. In this case, the first angle which is illustrated in FIG. 16 equals zero. FIG. 18 illustrates another example in which two fingers 860 and 870 are simultaneously touching a touchscreen at two positions 880 and 890, where the two forces 900 and 910 exerted by the two fingers are horizontal forces parallel to the touchscreen plane.

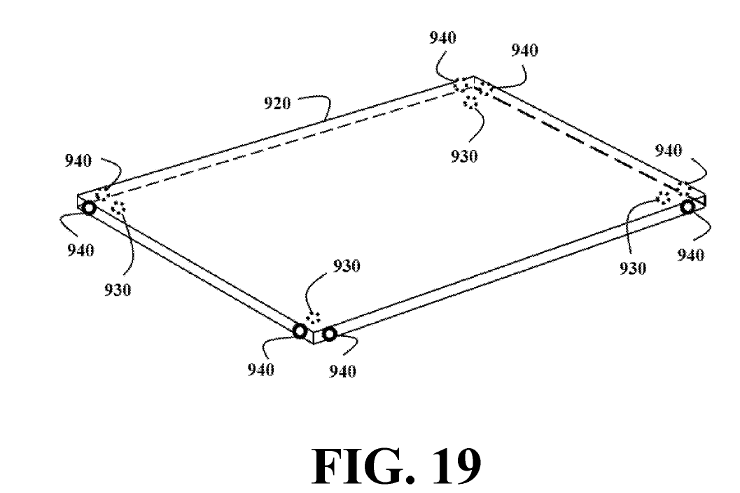

In one embodiment of the present invention, detecting the points of touch, the 3D directions of the forces, and the values of the forces exerted by the fingers on the touchscreen, is achieved by a plurality of force sensors. For example, FIG. 19 illustrates a touch panel 920 equipped with a first plurality of force sensors 930 positioned on the bottom surface of the touch pane to detect the vertical force exerted on each sensor. Also, a second plurality of sensors 930 are positioned on the side surfaces of the touch panel to detect the horizontal force exerted on each sensor. Analyzing the vertical forces and the horizontal forces on all sensors determines the points of touch, the 3D directions of the forces, and the values of the forces exerted from the fingers that touch the touchscreen. The U.S. patent application Ser. No. 12/587,339 explains this analysis and method in details.

Generally, the 3D direction and value of each force exerted on the touch panel can be determined by using methods or tools other than the force sensors. For example, the 3D direction of the force can be captured by a tracking camera. The value of the force exerted by the finger can also be determined by using a special touchscreen that detects the finger pressure or force. Also, the value of the force exerted by the finger can be determined, as known in the art, by measuring the area of finger's touch on the touchscreen, where each different area is associated with a certain finger pressure or force.

The touch panel described in the previous example can be a transparent surface designed to be attached to a touchscreen of a mobile phone, tablet, or a computer. It can also be a built-in component in the touchscreen of the mobile phone, tablet, or computer. It can also be used for touchpads of laptops or the like. In the case of using the present invention with a computer keyboard, the force sensors are positioned inside each button of the keyboard to enable detection of the user's identity when touching two or more buttons by two or more fingers. Also, in case of using the present invention with a computer mouse, the force sensors are positioned inside the left and right buttons of the mouse to detect the user's identity via the two buttons. The force sensors can also be positioned inside the chassis of the computer mouse to detect the user's identity once the chassis is touched by two or more fingers.

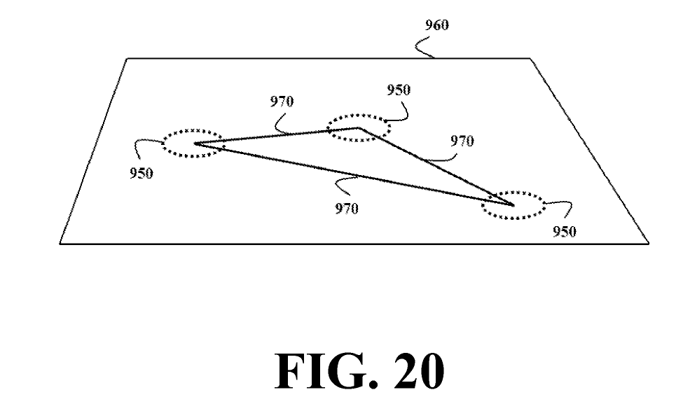

Once the points of touch, the 3D directions and values of the forces are detected, the distance between the points of touch and the ratio between the forces are calculated to retrieve the user's identity from the database. In one were to use, more than two fingers, the distances between each two successive points of touch and the angles between the lines that represent these distances are used in determining the user's identity. For example, FIG. 20 illustrates three spots or positions 950 on a touchscreen 960, simultaneously touched by three fingers. The lines 970 represent the distances between the centers of the spots. In this case, the lengths of the lines and the angles between the lines are stored in the database for use in detecting the user's identity. The same concept applies when using four or five fingers in user identity recognition by the present invention.

In another embodiment, the identity of the user can be recognized if two fingers or more are not touching the touchscreen at the same time. All that is required in this case is to have the hand supported at the same place without movement, while each finger is individually touching the touchscreen. The position of touch of each finger is detected to determine the distance between each two positions of touch. Also, the 3D direction and value of each force exerted from a finger is detected to determine the ratio between the forces. Accordingly, the user's identity can be recognized using the database, as previously described.

Finally, the presented invention can be described as a method for recognizing the identity of a hand skeleton by detecting the distribution pattern of the hand force through at least two fingers of the hand touching a surface, and checking the distribution pattern with a database that associates the distribution pattern with an identifier representing the hand skeleton.

Conclusively, while a number of exemplary embodiments have been presented in the description of the present invention, it should be understood that a vast number of variations exist, and these exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below. Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

1. A touchscreen that recognizes the identity of a user touching the touchscreen by two fingers of a hand wherein the touchscreen is comprised of;
a touch panel that detects the distance between the positions of touch of the two fingers;
a sensing unit that detects the three-dimensional directions and the ratio between the forces exerted by the two fingers on the touch panel;
a database that associates each unique combination of a distance, and three-dimensional directions and ratio between forces with a unique identity; and
a microprocessor that receives the data of the distance from the touch panel, and the data of the three-dimensional directions and the ratio from the sensing unit to search and retrieve the user's identity form the database.

2. The touchscreen of claim 1 wherein the two fingers are three or more fingers of a hand.

3. The touchscreen of claim 1 wherein the three-dimensional direction of each force of the forces is represented by a first angle located between the touch panel plane and a line representing the 3D direction of the force, and a second angle located between the x-axis and the projection of the line on the touch panel plane.

4. The touchscreen of claim 1 wherein the touch panel is a transparent surface to be attached to a touchscreen of a mobile phone, tablet device, or computer.

5. The touchscreen of claim 1 wherein the touch panel is attached to a computer keyboard, computer mouse, or touchpad.

6. The touchscreen of claim 1 wherein each unique combination of a distance, 3D directions and ratio represents a unique hand skeleton.

7. The touchscreen of claim 1 wherein the database is created by touching the touchscreen at all possible distances between the two fingers, and storing each distance with the corresponding 3D directions and values of the forces of the two fingers of a user.

8. The touchscreen of claim 1 wherein the database is created by automatically storing the distances between the two fingers, the three-dimensional directions and values of the forces of the two fingers each time a user touches the touchscreen.

9. The touchscreen of claim 1 wherein the three-dimensional direction is a two-dimensional direction parallel to the touch panel plane.

10. The touchscreen of claim 1 wherein the sensing unit utilizes a plurality of force sensors that detects the vertical forces and the horizontal forces exerted by the two fingers on the touch panel.

11. The touchscreen of claim 1 wherein the sensing unit utilizes other components than force sensors.

12. The touchscreen of claim 1 wherein the two fingers are simultaneously touching the touch panel

13. The touchscreen of claim 1 wherein the two fingers are successively touching the touch panel.

14. The touchscreen of claim 2 wherein the shape of the polygons connecting between the positions of touch is stored in the database to be utilized in determining the user's identity.

15. A method for recognizing the identity of a user touching a surface with at least two fingers of a hand wherein the method comprising;
detecting the distances and angles between the positions of touch between the at least two fingers and the surface;
detecting the three-dimensional directions and the ratio between the forces exerted by the at least two fingers on the surface;
checking a database, that associates each unique combination of a distance, angles, three-dimensional directions, and ratio with a unique identifier, to retrieve the user's identity.

16. The touchscreen of claim 15 wherein each unique combination of distances, angles, 3D directions, and ratio represents a unique hand skeleton.

17. The touchscreen of claim 1 wherein the three-dimensional direction is a two-dimensional direction parallel to the surface plane.

18. The touchscreen of claim 1 wherein the at least two fingers are simultaneously touching the surface.

19. The touchscreen of claim 1 wherein the at least two fingers are successively touching the surface.

20. A method for recognizing the identity of a hand skeleton by detecting the distribution pattern of the hand force through at least two fingers of the hand touching a surface, and checking the distribution pattern with a database that associates the distribution pattern with an identifier representing the hand skeleton.
